(19) United States
(12) Patent Application Publication
(10) Pub. No.: US 2002/0058094 A1
(43) Pub. Date: May 16, 2002

(54) Jelly-like seasoning and manufacturing method thereof

(76) Inventors: Akihiko Akamatsu, Ibo-gun (JP); Kotaro Matsumoto, Ibo-gun (JP); Ikuyo Maesaki, Ibo-gun (JP); Tomoko Kosugi, Ibo-gun (JP); Mayumi Sakatani, Ibo-gun (JP); Shinzou Kawaguchi, Ibo-gun (JP)

Correspondence Address: WENDEROTH, LIND & PONACK, L.L.P., 2033 K STREET N. W., SUITE 800, WASHINGTON, DC, 20006-1021, US

(21) Appl. No.: 09/941,843

(22) Filed: Aug. 30, 2001

(30) Foreign Application Priority Data
Sep. 5, 2000 (JP) 2000-268639
Feb. 20, 2001 (JP) 2001-042731
Feb. 20, 2001 (JP) 2001-043312
Mar. 9, 2001 (JP) 2001-066815

(51) Int. Cl. A23L 3/005; A23L 1/221

(52) U.S. Cl. 426/573; 426/575; 426/237; 426/638

(57) ABSTRACT

The objective of the present invention is to provide a jelly-like seasoning having a proper degree of fluidity when taken out from a tube-shaped container, presenting a jelly-like appearance when placed on foodstuffs and further providing a mild and new feeling of eating spreading in the mouth with melting when ea ten, and a manufacturing method thereof.

For that purpose, glucomannan and a gelatinizer composed of 1 or no less than 2 kinds of polysaccharide reactive to glucomannan selected from among xanthan gum, locust bean gum, carrageenan, gellangum and other polysaccharides reactive to glucomannan are added to a liquid seasoning, in the state suspended in a non-soluble liquid such as ethyl alcohol, etc., dispersed in the liquid seasoning and then heated, to obtain a jelly-like seasoning with a gel strength of 10 to 80 g/cm².

### BACKGROUND OF THE INVENTION

The present invention relates to a jelly-like seasoning and a manufacturing method thereof, more specifically a jelly-like seasoning having a proper degree of fluidity when taken out from a tube-shaped container, presenting a jelly-like appearance when placed on foodstuffs and further providing a mild and new feeling of eating spreading in the mouth with melting when eaten, and a manufacturing method thereof.

Conventionally, there are powdery, granular or granulated seasonings such as pepper, salt, sugar, etc., liquid seasonings such as soy sauce, mirin (=sweet sake used as seasoning), etc. and pasty seasonings such as mayonnaise, ketchup, etc.

And, those seasonings provide foodstuffs with desired flavour by penetrating into the foodstuff, etc., when added to a foodstuff.

By the way, though suitable to conventional cooking methods, such powdery, granular or granulated, liquid and semi-liquid seasonings presented problems such as easily flying or spilling or difficulty of handling, etc. in applications for fast foods or stand-up meals, etc. Moreover, it was difficult for those conventional seasonings, except for pasty seasonings such as mayonnaise, ketchup, etc., to provide foodstuff with a flavour individually for each mouthful of the material.

### SUMMARY OF THE INVENTION

The objective of the present invention, realized in view of said problems with conventional seasonings, is to provide a jelly-like seasoning having a proper degree of fluidity when removed from a tube-shaped container, that has a jelly-like appearance when placed on foodstuffs and further providing a mild and new taste sensation that spreads throughout the mouth when eaten, and a manufacturing method thereof.

To achieve said objective, the jelly-like seasoning according to the present invention is characterized in that it contains a seasoning, glucomannan, and a gelatinizer comprised of 1 or no less than 2 kinds of polysaccharide reactive to glucomannan selected from among xanthan gum, locust bean gum, carrageenan, gellangum and other polysaccharides reactive to glucomannan, has a gel strength of 10 to 80 g/cm², and has a jelly-like appearance.

Here, “gel strength” indicates the maximum load measured by using an 8 mmØ plunger and a rheometer with a range width of 0 to 2 kg, when the plunger is placed into a jelly-like seasoning at a temperature of 5° C. and a thickness of 30 mm at a rising speed of 60 mm/min of the sample stand.

This jelly-like seasoning contains a seasoning and a gelatinizer comprised of polysaccharide(s) reactive to glucomannan, has a gel strength of 10 to 80 g/cm², and has a jelly-like appearance. For that reason, it has a proper degree of fluidity when removed from a tube-shaped container, has a jelly-like appearance when placed on foodstuffs, and provides a mild and new taste sensation when spreading throughout the mouth when eaten, and can be suitably used for applications such as fast food, buffet parties, etc. because it is easy to handle without flying or spilling when applied on foodstuffs or placed between foodstuffs and can be used to individually season foodstuff for each mouthful.

Furthermore, this jelly-like seasoning, which uses glucomannan and polysaccharide reactive to glucomannan as gelatinizer, is rich in dietary fiber and low in calories, and is therefore a seasoning desirable from the viewpoint of health.

In this case, an edible solid matter in the form of small pieces may be blended in such a way that it can be dispersed uniformly.

This makes it possible to put an edible solid matter in the form of small pieces on a foodstuff in a uniform state and, even after that, this edible solid matter has a jelly-like appearance without separating or sedimentation and uniformly spreads throughout the mouth when eaten.

It should be noted that in recent years, a lot of jelly-like foodstuffs containing glucomannan and high in elasticity have been commercialized. The manufacturing process of this jelly-like foodstuff consists of mixing glucomannan with water, heating the mixture to make the glucomannan swell, and adding an other gelatinizer to it, further heating and cooling it as required, and then filling it into a prescribed container.

In the case where this manufacturing method of jelly-like foodstuff is applied to the manufacture of the jelly-like seasoning according to the present invention, with a gel strength much smaller compared with conventional jelly-like foodstuffs, glucomannan is liable to become lumpy, i.e. granular lumps, because of the characteristics of glucomannan, and it was rather difficult to manufacture a homogenous jelly-like seasoning.

For that reason, in the manufacturing method of the jelly-like seasoning according to the present invention, a gelatinizer comprised of glucomannan and 1 or no less than 2 kinds of polysaccharide reactive to glucomannan selected from among xanthan gum, locust bean gum, carrageenan, gellangum and other polysaccharides reactive to glucomannan is added, in a state where it is suspended in a non-soluble liquid like ethyl alcohol, etc., to a liquid seasoning to be dispersed in the liquid seasoning, and then heated, making it possible to obtain a jelly-like seasoning with a gel strength of 10 to 80 g/cm².

This jelly-like seasoning manufacturing method, which consists in adding glucomannan and a gelatinizer, comprised of polysaccharides reactive to glucomannan, in a state where it is suspended in a non-soluble liquid like ethyl alcohol, etc., to a liquid seasoning to be dispersed in the liquid seasoning, and then heating that liquid, makes it difficult for the glucomannan to become lumpy, and can produce a good quality jelly-like seasoning which is homogenous and free from air bubbles.

In this case, the heating can be done after addition of an edible solid matter in the form of small pieces.

This makes it possible to manufacture a jelly-like seasoning of good quality in which an edible solid matter in the form of small pieces is uniformly dispersed.

Furthermore, said heating can be made with Joule's heat, produced by directly applying electric current to a raw material in which a gelatinizer is uniformly dispersed in a liquid seasoning while conveying that material.

This makes it possible to uniformly heat the raw material by quickly producing heat throughout the entire raw material, and simultaneously preventing the glucomannan from becoming lumpy, and manufacture a good quality jelly-like seasoning which is homogenous and free from air bubbles, while preventing burning yet sterilizing the material.

### BRIEF DESCRIPTION OF THE DRAWINGS

FIG. 1 is a flow chart showing an embodiment of the manufacturing method of jelly-like seasoning according to the present invention.

FIG. 2 is an explanatory drawing showing an example of the agitator used for manufacturing the jelly-like seasoning according to the present invention.

FIG. 3 is an explanatory drawing showing an example of Joule heating apparatus used for manufacturing the jelly-like seasoning according to the present invention.

### DETAILED DESCRIPTION OF THE INVENTION

Explanation will be given hereafter on the jelly-like seasoning and the manufacturing method thereof according to the present invention.

The jelly-like seasoning of the present invention contains a seasoning, glucomannan, and a gelatinizer composed of 1 or no less than 2 kinds of polysaccharide reactive to glucomannan selected from among xanthan gum, locust bean gum, carrageenan, gellangum and other polysaccharides reactive to glucomannan, has a gel strength of 10 to 80 g/cm², and presents a jelly-like appearance. For that reason, this jelly-like seasoning has a proper degree of fluidity when taken out from a tube-shaped container, presents a jelly-like appearance when placed on foodstuffs, and spreads in the mouth with melting when eaten.

In the jelly-like seasoning of the present invention may also be blended an edible solid matter in the form of small pieces in a way to be dispersed about uniformly, as required.

In this case, as seasoning used for the jelly-like seasoning, one may use, though not particularly restricted, ordinary dressing, general liquid seasonings such as ponzu (juice pressed from bitter orange), soy sauce for sashimi, mentsuyu (a kind of soy sauce used mainly for noodles), tare (seasoning soup used for roasted meats), Worcestershire sauce, etc. and other liquid of seasonings prepared by blending various kinds of seasoning such as sugar, vinegar, soy sauce, mirin, sake, etc., juice of citrus fruits such as sudachi, yuzu (Chinese lemon), kabosu, daidai (kinds of bitter orange), etc., essence of dried bonito strips, kelp, chicken, beef, flavory vegetables, etc., flavory seasonings such as spices, sesame seed, fruits, etc., and milk products, etc.

Moreover, as gelatinizer, one may use glucomannan and 1 or no less than 2 kinds of polysaccharide reactive to glucomannan selected from among xanthan gum (polysaccharide obtained from products of fermentation of fungus body <Xantho monas campestris>), locust bean gum (polysaccharide obtained from alubumin of seed of carob which is a perennial evergreen tree of pulse family), carrageenan (polysaccharide obtained from kelp <red algae>), gellangum (polysaccharide obtained from products of fermentation of fungus body <pseudo monas elodea>) and other polysaccharides reactive to glucomannan.

Here, mainly, xanthan gum discharges the function of promoting gelation by reacting with glucomannan, locust bean gum plays the role of raising water holding capacity, carrageenan takes the action of improving the eating feeling (smoothness) in the case where pasty seasoning such as tare soup for roasted meats, sesame, etc. as seasoning, and gellangum performs the action of increasing fluidity, respectively.

It has been confirmed that those gelatinizers can provide a jelly-like seasoning which takes the form of jelly at the target gel strength of 10˜80 g/cm², when mixed at a rate of approximately 0.1˜1.0 wt %.

Furthermore, as edible solid matter which can be blended as required, a material of flat or cubic shape with a long side of 1˜10 mm, particularly with a long side of 5 mm or so, is suita content, determined by physical properties and flavour, shall preferably be in a proportion of 0.01˜10 wt %.

And, as edible solid matter to be blended, one may use, to be concrete, ginger, wasabi (a kind of spice originated in Japan), myôga (Japanese ginger), fruit or leave of perilla or pepper, skin or flesh of citrous fruits such as Chinese lemon, sudachi, mandarin orange, etc., herbs such as parsley, basil, etc., flesh of sesame, corn, ume (Japanese apricot), aloe, etc., vegetables such as onion, tomato, etc., nuts such as almond, walnut, etc., sakura-shrimp, dried adductor muscle, kelp, flower or leave of cherry tree, maple, etc., capsicum, etc., and those materials may be used either independently or in combination, as required, after processing to proper size described above.

In passing, the apparent specific gravity of those edible solid matters is 1.00 with dried leave of blue perilla, 0.90 with grated ginger, 0.86 with white roasted sesame, 0.86 with dried skin of yuzu, 0.83 with sliced onion, and 0.83 with dried basil leave, for example.

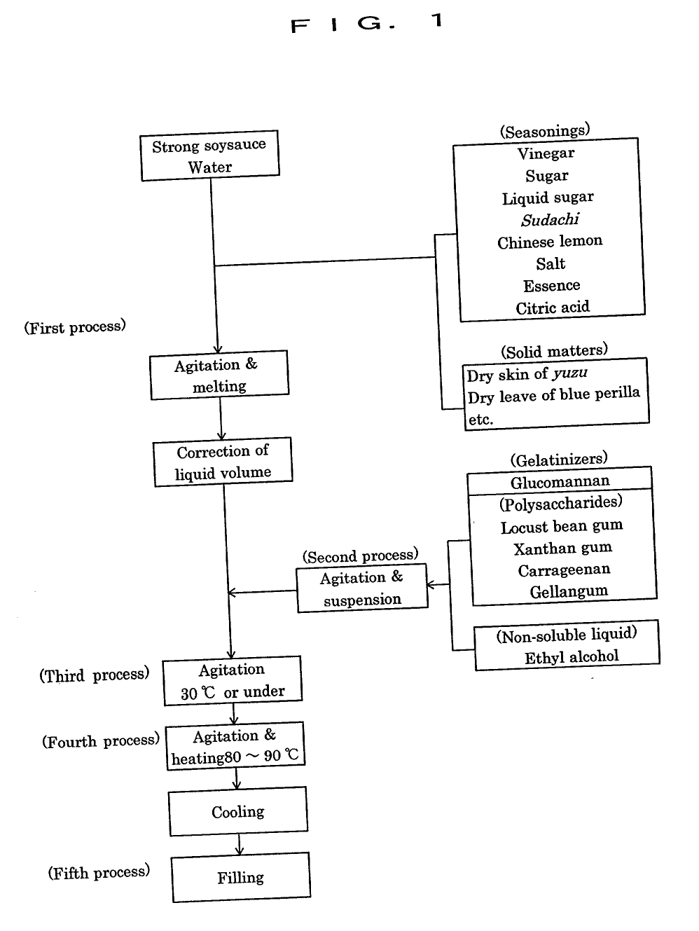

Next, the manufacturing method of jelly-like seasoning will be explained hereafter, based on the manufacturing flow indicated in FIG. 1, by taking an example of jelly-like seasoning with a flavour of yuzu (non-oil dressing) (Embodiment 1).

### Embodiment 1)

### See No. 1 in Table 1

| Raw materials: | | |
|---|---|---|
| Strong soy sauce | 10 | wt % |
| Vinegar | 9 | wt % |
| Sugar | 9 | wt % |
| Liquid sugar | 9 | wt % |
| Sudachi | 3 | wt % |
| Chinese lemon | 3 | wt % |
| Salt | 2 | wt % |
| Seasoning | 0.2 | wt % |
| Citric acid | 0.2 | wt % |
| Gelatinizer (total) | 0.586 | wt % |

(See No. 1 in Table 1 for the details.)

| Alcohol | 4 | wt % |
|---|---|---|
| Water | Rest | |
| Total | 100 | wt % |

TABLE 1

| | | Type and blending volume of gelatinizer | | | | | |
|---|---|---|---|---|---|---|---|
| | Jelly-like | | Locust bean | Xanthan | | | |
| No. | seasoning | Glucomannan | gum | gum | Carrageenan | Gellangum | Total |
| 1 | Flavour of yuzu | 0.250 | 0.096 | 0.176 | — | 0.064 | 0.586 |
| 2 | | 0.250 | 0.120 | 0.220 | — | 0.080 | 0.670 |
| 3 | | 0.250 | 0.200 | 0.110 | — | 0.072 | 0.632 |
| 4 | Flavour of soy | 0.250 | 0.070 | 0.039 | — | 0.029 | 0.388 |
| 5 | sauce for sashimi | 0.250 | 0.096 | 0.176 | — | 0.064 | 0.586 |
| 6 | Flavour of | 0.250 | 0.120 | — | 0.083 | 0.030 | 0.483 |
| 7 | seasoning soup for | 0.250 | 0.192 | — | 0.132 | 0.040 | 0.614 |
| | roasted meat | | | | | | |
| 8 | Flavour of sesame | 0.265 | 0.201 | 0.041 | 0.081 | — | 0.588 |
| 9 | | 0.230 | 0.263 | 0.053 | 0.105 | — | 0.651 |
| 10 | Flavour of | 0.040 | 0.035 | 0.007 | 0.024 | — | 0.106 |
| 11 | chicken consommé | 0 049 | 0.039 | 0.008 | 0.029 | — | 0.125 |
| 12 | | 0.162 | 0.125 | 0.230 | — | 0.083 | 0.600 |
| 13 | | 0.189 | 0.146 | 0.270 | — | 0.090 | 0.695 |

| | | Gel | Quality characteristics | | | | |
|---|---|---|---|---|---|---|---|
| | Jelly-like | strength | Jelly-like | | Eating | Separation | Evaluation |
| No. | seasoning | (g/cm²) | appearance | Fluidity | feeling | from water | mark |
| 1 | Flavour of yuzu | 16 | ++ | ++ | + | ± | 5 |
| 2 | | 23 | ++ | ++ | ++ | − | 7 |
| 3 | | 74 | +++ | + | +++ | − | 8 |
| 4 | Flavour of soy | 18 | + | +++ | ++ | + | 5 |
| 5 | sauce for sashimi | 30 | + | +++ | ++ | + | 5 |
| 6 | Flavour of | 48 | + | + | ++ | ± | 4 |
| 7 | seasoning soup for | 80 | + | + | ++ | ± | 4 |
| | roasted meat | | | | | | |
| 8 | Flavour of sesame | 27 | ++ | ++ | ++ | + | 5 |
| 9 | | 53 | ++ | + | +++ | ± | 6 |
| 10 | Flavour of | 12 | + | +++ | + | + | 4 |
| 11 | chicken consommé | 16 | ++ | +++ | ++ | + | 6 |
| 12 | | 42 | +++ | ++ | +++ | ± | 8 |
| 13 | | 70 | +++ | + | ++ | − | 7 |

This jelly-like seasoning with a flavour of yuzu is prepared, in the first place, by adding vinegar, sugar, liquid sugar, essence of sudachi, yuzu, salt, dried bonito strip, kelp, chicken, beef, flavory vegetables, etc., seasoning such as citric acid, etc. to strong soy sauce diluted with water, agitating it for melting, while supplementing the volume of liquid as required (first process).

And, to this liquid seasoning may be added prescribed volume of optional edible solid matter such as leave of blue perilla or its dry product or skin of yuzu or its dry product, etc.

This addition of edible solid matter may be made at any time before the fourth process of heating and stirring.

Next, in another vessel are mixed and agitated glucomannan, a gelatinizer composed of 1 or no less than 2 kinds of polysaccharide reactive to glucomannan selected from among xanthan gum, locust bean gum, carrageenan, gellangum and other polysaccharides reactive to glucomannan (3 kinds or xanthan gum, locust bean gum, and gellangum in this embodiment), and 95 wt % ethyl alcohol as non-soluble liquid (second process).

In this case, the non-soluble liquid shall be used in a volume no less than twice, preferably no less than 4 times, as much as gelatinizer in weight.

A mixture of gelatinizer, non-soluble liquid and ethyl alcohol blended and agitated in this way remains in a state of suspension because the gelatinizer does not dissolve in the ethyl alcohol.

There is no particular sequential relation between the first process and the second process, and it is also possible to execute the two processes simultaneously in parallel.

The gelatinizer in a state suspended in the non-soluble liquid obtained in the second process as described above is added to the liquid seasoning obtained in the first process, to disperse the gelatinizer in the liquid seasoning (third process).

In this case, the liquid seasoning obtained in the first process is set at normal temperature, preferably in the temperature range of 0˜30° C., so that the gelatinizer may be dispersed in the liquid seasoning in an ungelatinized state. At that time, the gelatinizer suspended in ethyl alcohol as non-soluble liquid gets in contact, through the ethyl alcohol, with the water content contained in the liquid seasoning and, for that reason, it becomes possible to delay the time for the gelatinizer to swell by absorbing water content, compared with a case in which the gelatinizer directly gets in contact with the water content, and thus prevent formation of lumps by glucomannan, enabling uniform dispersion of the gelatinizer in the liquid seasoning.

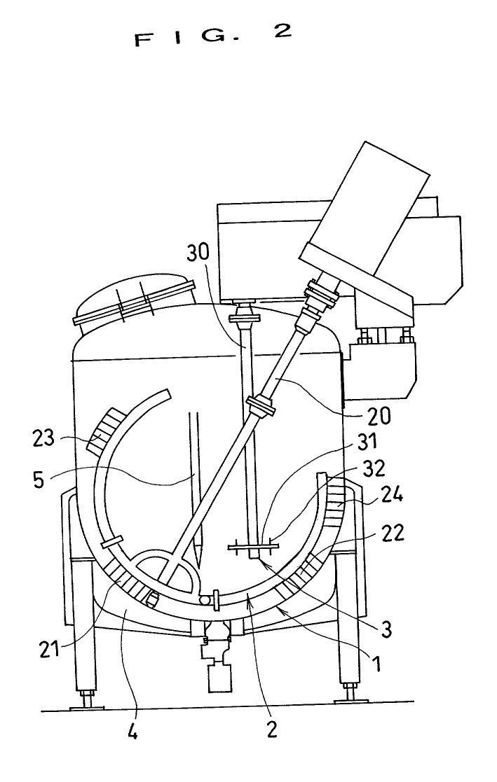

Moreover, as agitator to be used for this third process (and for the fourth process to be described later), one may suitably use, though not particularly restricted, an agitator provided with scrapers 21, 22, 23, 24 to be slidably in contact with the bottom of an agitating tank 1 for forcibly and uniformly stirring the entire space in the tank including the bottom of the agitating tank 1, provided at the lower end with a bottom agitating blade 2 to be rotatably driven by a slant rotary shaft 20 and a disc 31 formed on a projection 32 for crushing lumps of gelatinizer with shearing action, and also provided with an auxiliary agitating blade 3 rotatably driven by a vertical rotary shaft 30, a heating mechanism 4 and a temperature sensor 5, as shown in FIG. 2.

And, it is so arranged as to uniformly disperse the gelatinizer in the liquid seasoning without forming lumps of glucomannan, by rotatably driving both the slant rotary shaft 20 and the vertical rotary shaft 30.

And, after the gelatinizer is uniformly dispersed in the liquid seasoning as described above, this liquid seasoning is agitated while heating to gelatinize the gelatinizer swollen by absorbing water content, and then cooled to the prescribed temperature, as required (fourth process).

In this case, the heating temperature is set, preferably in the temperature range of 80˜90° C., to make the gelatinizer gelate in a state uniformly dispersed in the liquid seasoning.

Furthermore, as agitator to be used for this fourth process, one may use the agitator used for the third process, though not particularly restricted. At that time, the vertical rotary shaft 30 shall be kept not to be rotatably driven.

After that, the liquid seasoning in which the gelatinizer is gelatinized is filled in a vessel such as tube, etc. or a bag, in the state held at a temperature not easily showing gel strength or, to be concrete, at no less than 50° C. and preferably at 60° C.˜70° C. (fifth process).

It has been confirmed that the jelly-like seasoning with a flavour of yuzu obtained this way takes the form of jelly with a gel strength of 16 g/cm², as shown in No. 1 of Table 1, shows good fluidity and has a proper degree of fluidity when taken out from a tube-shaped container in which it is charged, presenting a jelly-like appearance when placed on foodstuffs and further providing a feeling of spreading in the mouth with melting when eaten.

In this case, the gel strength and the quality characteristics of the jelly-like seasoning indicated in Table 1 were measured by the following methods:

(1) Gel strength: Expressed with the maximum load measured by using a plunger of 8 mmØ and a rheometer with a range width of 0 to 2 kg, when the plunger is made to get into the jelly-like seasoning at a temperature of 5° C and a thickness of 30 mm at a rising speed of 60 mm/min of the sample stand.

(2) Jelly-like appearance: Expressed in 5-grade evaluation (+++, ++, +, ±, −), in comparison with gelatin jelly, with a state visually close to gelatin jelly as +++ (the larger the number of + the closer to gelatin jelly).

(3) Fluidity: The degree of ease of pushing out the jelly-like seasoning with a single hand from a flexible tube-shaped container in which it is charged is expressed in 5-grade evaluation (+++, ++, +,±−) (the larger the number of + the better the fluidity).

(4) Feeling of eating: The spreading of taste in the mouth is expressed in 5-grade evaluation (+++, ++, +, ±, −), in comparison with gelatin jelly, with a state close to gelatin jelly as +++ (the larger the number of + the closer to gelatin jelly).

(5) Separation from water: Expressed in 3-grade evaluation (−, ±,+) (− for without separation from water, + for presence of separation from water).

(6) Evaluation mark: The marks were assigned as +++: 3 marks, ++: 2 marks, +: 1 mark, ±: 0 mark, −: −1 mark for 5-grade evaluation, and as −: 1 mark, ±: 0 mark, +: −1 mark for 3-grade evaluation, and the total figures were taken as evaluation marks.

This evaluation was made by 5 panelists selected from among the R&D staff members of Japan Marten Soy Sauce Co., Ltd.

For jelly-like seasoning with a flavour of yuzu, examples with modified blending proportion of gelatinizer are indicated in No. 2 and No. 3 of Table 1, in addition to said Embodiment 1 (No. 1 in Table 1). It has been confirmed that both of them take the form of jelly with a gel strength of 23 g/cm² and 74 g/cm² respectively, in the same way as Embodiment 1, show good fluidity and have a proper degree of fluidity when taken out from the tube-shaped containers in which they are charged, presenting a jelly-like appearance when placed on foodstuffs and further providing a feeling of spreading in the mouth with melting when eaten.

Next, explanation will given on a jelly-like seasoning with a flavour of soy sauce for sashimi (Embodiment 2) manufactured by the same method as the manufacturing method of jelly-like seasoning with a flavour of yuzu in said Embodiment 1 (No. 1 in Table 1).

### Embodiment 2

### See No. 4 in Table 1

| Raw materials | | |
|---|---|---|
| Soy sauce for sashimi | 50 | wt % |
| Gelatinizer (total) | 0.388 | wt % |

(See No. 4 in Table 1 for the details.)

| Alcohol | 4 | wt % |
|---|---|---|
| Water | Rest | |
| Total | 100 | wt % |

It has been confirmed that jelly-like seasoning with a flavour of soy sauce for sashimi obtained this way takes the form of jelly with a gel strength of 18 g/cm² (30 g/cm²) respectively, in the same way as Embodiment 1, shows good fluidity and has a proper degree of fluidity when taken out from the tube-shaped containers in which it is charged, presenting a jelly-like appearance when placed on foodstuffs and further providing a feeling of spreading in the mouth with melting when eaten, as shown in No. 4 in Table 1 (the same is true with No. 5 in Table 1 with modified blending proportion of gelatinizer).

Next, explanation will given on a jelly-like seasoning with a flavour of tare soup for roasted meats (Embodiment 3) manufactured by the same method as the manufacturing method of jelly-like seasoning with a flavour of yuzu in said Embodiment 1 (No. 1 in Table 1).

### Embodiment 3

### See No. 6 in Table 1

| Raw materials | | |
|---|---|---|
| Tare soup for roasted meats | 50 | wt % |
| Gelatinizer (total) | 0.483 | wt % |

(See No. 6 in Table 1 for the details.)

| Alcohol | 4 | wt % |
|---|---|---|
| Water | Rest | |
| Total | 100 | wt % |

It has been confirmed that jelly-like seasoning with a flavour of tare soup for roasted meats obtained this way takes the form of jelly with a gel strength of 48 g/cm² (80 g/cm²) respectively, in the same way as Embodiment 1, shows good fluidity and has a proper degree of fluidity when taken out from the tube-shaped containers in which it is charged, presenting a jelly-like appearance when placed on foodstuffs and further providing a feeling of spreading in the mouth with melting when eaten, as shown in No. 6 in Table 1 (the same is true with No. 7 in Table 1 with modified blending proportion of gelatinizer).

In addition to above, it has also been confirmed that jelly-like seasoning with a flavour of sesame and that with a flavour of chicken consomme manufactured by the same method as the manufacturing method of jelly-like seasoning with a flavour of yuzu in said Embodiment 1 (No. 1 in Table 1) take the form of jelly with a gel strength of 27 g/cm² and 53 g/cm², 12 g/cm² to 70 g/cm² respectively, in the same way as Embodiment 1, shows good fluidity and have a proper degree of fluidity when taken out from the tube-shaped containers in which they are charged, presenting a jelly-like appearance when placed on foodstuffs and further providing a feeling of spreading in the mouth with melting when eaten, as shown in No. 8 and No. 9, No. 10 to No. 13 in Table 1 (all of which indicate examples with modified blending proportion of gelatinizer).

Next, explanation will be given in further detail on an embodiment of the jelly-like seasoning according to the present invention, realized in such a way that an edible solid matter in the form of small pieces is blended in a way to be dispersed about uniformly.

A stock liquid was prepared by mixing various kinds of raw materials at normal temperature no higher than 30° C., and dispersing a gelatinizer in them according to the test zone in Table 2.

Table 3 indicates the characteristic values in the respective test zones.

As edible solid matter was used either dry skin of yuzu or dry leave of blue perilla. Both of them had a long side of approximately 5 mm, and the dry skin of yuzu was of square shape while the dry leave of blue perilla was of flat shape.

The edible solid matter is added in a proportion of 0.01˜10 wt %, particularly preferably in a proportion of 0.05˜0.1 wt % against the jelly-like seasoning.

This stock liquid was gelatinized by heating at 85° C. for 10 minutes, and submitted to the following tests:

As gelatinizer were used glucomannan, xanthan gum, locust bean gum and gellangum. The concentration of the gelatinizer was changed each time without changing the blending ratio of the 4 kinds for preparation.

The gelatinized gelatinizer took a form of sol at high temperature (80° C.) but presented a form of gel at medium and low temperature (40˜20° C.).

TABLE 2
Blending of gelatinizer and test zones
(contents of test zones with modified gelatinizer in Table 1)

| Composition of | | Test | Test | Test | Test | Test |
|---|---|---|---|---|---|---|
| gelatinizer | Blank | zone 1 | zone 2 | zone 3 | zone 4 | zone 5 |
| Glucomannan | 0 | 0.092 | 0.184 | 0.276 | 0.368 | 0.460 |
| Xanthan gum | 0 | 0.010 | 0.019 | 0.029 | 0.038 | 0.048 |
| Locust bean gum | 0 | 0.018 | 0.036 | 0.054 | 0.072 | 0.090 |
| Gellangum | 0 | 0.006 | 0.013 | 0.019 | 0.026 | 0.032 |
| Total | 0 | 0.126 | 0.252 | 0.378 | 0.504 | 0.630 |

TABLE 3
Characteristic values in respective test zones

| | Brix degree | Viscosity | Gel strength |
|---|---|---|---|
| | (%) | (cps) | (g/cm²) |
| Blank | 30.6 | 0 | — |
| Test zone 1 | 30.8 | 15 | — |
| Test zone 2 | 31.0 | 23 | 2 |
| Test zone 3 | 31.1 | 52 | 6 |
| Test zone 4 | 31.3 | 85 | 16 |
| Test zone 5 | 31.5 | 97 | 22 |

Here, explanation will be given on the behaviour of edible solid matter in gel liquid in the form of sol and gel.

The gel liquid was put in a 200 mL beaker to a level of 60 mm from the bottom and, after being held for an hour at each of the 7 different levels of temperature of 0° C. to 60° C. with an interval of 10° C., agitated for 5 minutes. After stopping the agitation, the motion of the solid matter found at 20 mm below the surface of the liquid was observed as indicator.

The edible solid matter settled in some test zones and floated up in others depending on the difference of specific gravity in sol state (80° C.), but maintained a uniformly dispersed state without reaching neither the top end nor the bottom at a viscosity of 52 cps or over, as seen in test zones 3˜5 in Table 3.

And yet, in sol state having a gel strength of 6 g/cm² or over (40˜20° C.), the uniformly dispersed state of the edible solid matter became stronger and did not show any movement.

The manufacturing process of a jelly-like seasoning containing such edible solid matter is all right if only it is constructed with an equipment provided with an agitator, and arranged in a way to perform gelatinization of the material while stirring and fill it into a vessel while stirring.

The edible solid matter is uniformly dispersed, as far as agitation is continued, even if it takes the form of sol at high temperature, and the date indicates that the edible solid matter can maintain a uniformly dispersed state in the liquid in the state without agitation to the vessel, for a maximum period of an hour.

The manufacturing process will be all right if it is arranged in a way to cool the material together with the vessel for a period within an hour, preferably within 20 minutes after the filling, and the cooling may be made with either water or cold air, if only precautions normally required for the manufacture of foodstuff are taken.

Therefore, in a system in which the material is filled into a vessel while stirring as described above, the material can be turned into products while maintaining dispersion if its gel strength is no lower than 6 g/cm².

Generally, a suspended solid in a solution follows the physical principle of gravity or buoyancy. In a solution taking the form of sol-gel, however, the movement of the suspended solid is restricted by either gravity or buoyancy if its gel strength is low, and by the intermolecular force forming the gel structure if its gel strength is high.

A suspended solid is believed to settle with gravity if it absorbs water even if its apparent specific gravity is lighter than water, and float with buoyancy which prevails if there is no absorption of water.

Therefore, in a solution taking the form of sol-gel, the edible solid matter follows the physical principle of gravity or buoyancy if its gel strength is low but, if the gel strength is high, the intermolecular force forming the gel structure prevails and the edible solid matter is confined and fixed in it. In that case, it is believed that the intermolecular force prevails at a gel strength of 6 g/cm² or over.

And, as jelly-like seasonings containing an edible solid matter were manufactured with components indicated in Table 4 and Table 5 below, the edible solid matter was dispersed in an about uniform state without moving in all of the jelly-like seasonings obtained, not only at normal temperature but also almost up to 50° C.

And, also in jelly-like seasonings after being stored in transparent vessels, about uniform dispersion of the edible solid matter was visually confirmed.

In jelly-like seasonings obtained this way, those in which the seasoning and the edible solid matter are blended about uniformly can be obtained easily, and they were handy and of good quality, without requiring an action of mixing immediately before use, etc. for homogenizing the product as it is the case with conventional seasonings.

TABLE 4

| | | Blending |
|---|---|---|
| | | volume |
| Type | Use | (wt %) |
| Soy sauce | Seasoning | 26 |
| Vinegar | Seasoning | 22 |
| Essence of dried | Seasoning | 18 |
| bonito strips | | |
| Sugar | Seasoning | 18 |
| Sodium glutamate | Seasoning | 1 |
| Nucleic acid based | Seasoning | 0.1 |
| seasoning | | |
| Dry skin of yuzu | Solid matter | 0.1 |
| Glucomannan | Gelation | 0.3 |
| Xanthan gum | Gelation | 0.03 |
| Locust bean gum | Gelation | 0.05 |
| Gellangum | Gelation | 0.02 |
| Alcohol | Manufacturing | 4 |
| | agent | |
| Water | Manufacturing | 10.4 |
| | agent | |
| Total | | 100 |

TABLE 5

| | | Blending |
|---|---|---|
| | | volume |
| Type | Use | (wt %) |
| Soy sauce | Seasoning | 26 |
| Vinegar | Seasoning | 22 |
| Essence of dried | Seasoning | 18 |
| bonito strips | | |
| Sugar | Seasoning | 18 |
| Sodium glutamate | Seasoning | 1 |
| Nucleic acid based | Seasoning | 0.1 |
| seasoning | | |
| Flakes of blue | Solid matter | 0.05 |
| perilla | | |
| Glucomannan | Gelation | 0.3 |
| Xanthan gum | Gelation | 0.03 |
| Locust bean gum | Gelation | 0.05 |
| Gellangum | Gelation | 0.02 |
| Alcohol | Manufacturing | 4 |
| | agent | |
| Water | Manufacturing | 10.45 |
| | agent | |
| Total | | 100 |

By the way, the heating of the raw material in which said gelatinizer is uniformly dispersed in a liquid season can be made with Joule's heat by directly applying electric current to the raw material while transporting the material.

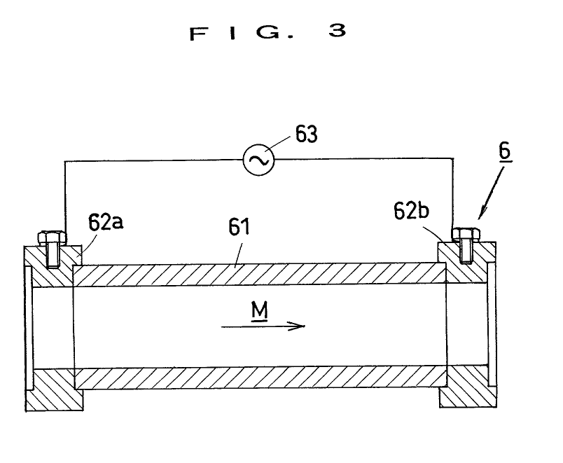

This heating method consists in introducing a raw material in which a gelatinizer is uniformly dispersed in a liquid season, by mixing the liquid seasoning obtained in said first process with the gelatinizer in the state suspended in a non-soluble liquid obtained in said second process in a tube (non illustrated), for example, into a Joule heating apparatus 6 realized by disposing, at both ends of an insulating tube 61, flange-shaped electrodes 62a, 62b connected to a power source 63, as shown in FIG. 3, and heating the raw material M with the Joule's heat produced by directly applying electricity to the raw material M through the electrodes 62a, 62b during transportation through the insulating tube 61.

This makes it possible to uniformly heat the entire raw material M rapidly and simultaneously, prevent the glucomannan from getting into a shape of lumps, and manufacture a jelly-like seasoning of good quality which is homogenous and free from air bubbles, while preventing burning and sterilizing the material.

The power source 63 of the Joule heating apparatus 6 shall preferably be an AC power source 63 and, by controlling it with inverter, it becomes possible to easily control the heating of the raw material M, depending on the properties of the raw material M, volume of the raw material M transported through the insulating tube 61, etc.

The jelly-like seasoning according to the present invention and the manufacturing method for it have so far been explained based on its embodiment, but this invention is not restricted to the construction described in said embodiment but its construction may be changed as required to the extent it does not deviate from the essential purpose of the invention.

1. A jelly-like seasoning characterized in that it contains a seasoning, glucomannan, and a gelatinizer comprised of 1 or no less than 2 kinds of polysaccharide reactive to glucomannan selected from among xanthan gum, locust bean gum, carrageenan, gellangum and other polysaccharides reactive to glucomannan, has a gel strength of 10 to 80 g/cm², and has a jelly-like appearance.

2. A jelly-like seasoning as defined in claim 1, wherein an edible solid matter in the form of small pieces is blended in such a way that it can be dispersed about uniformly.

3. A manufacturing method a of jelly-like seasoning characterized in that a gelatinizer comprised of glucomannan and 1 or no less than 2 kinds of polysaccharide reactive to glucomannan selected from among xanthan gum, locust bean gum, carrageenan, gellangum and other polysaccharides reactive to glucomannan is added, in a state where it is suspended in a non-soluble liquid like ethyl alcohol, etc., to a liquid seasoning to be dispersed in the liquid seasoning, and then heated, making it possible to obtain a jelly-like seasoning with a gel strength of 10 to 80 g/cm².

4. A manufacturing method of a jelly-like seasoning as defined in claim 3, wherein an edible solid matter in the form of small pieces is blended in such a way to be dispersed uniformly.

5. A manufacturing method of a jelly-like seasoning as defined in claim 3, wherein said heating is made with Joule's heat produced by directly applying electric current to a raw material in which a gelatinizer is uniformly dispersed in a liquid seasoning while conveying that material.

6. A manufacturing method of a jelly-like seasoning as defined in claim 4, wherein said heating is made with Joule's heat produced by directly applying electric current to a raw material in which a gelatinizer is uniformly dispersed in a liquid seasoning while conveying that material.
